(19) United States
(12) Patent Application Publication
(10) Pub. No.: US 2024/0185235 A1
(43) Pub. Date: Jun. 6, 2024

(54) METHOD AND APPARATUS FOR PROVING CONTINUOUS ACTION UNIQUENESS USING CRYPTOGRAPHIC HASH

(71) Applicant: INDUSTRY-ACADEMIC COOPERATION FOUNDATION, DANKOOK UNIVERSITY, Yongin-si Gyeonggi-do (KR)

(72) Inventor: Young Bom PARK, Seongnam-si (KR)

(73) Assignee: INDUSTRY-ACADEMIC COOPERATION FOUNDATION, DANKOOK UNIVERSITY, Yongin-si Gyeonggi-do (KR)

(21) Appl. No.: 18/497,366

(22) Filed: Oct. 30, 2023

(30) Foreign Application Priority Data
Dec. 2, 2022 (KR) 10-2022-0167050

(51) Int. Cl. G06Q 20/38; G06Q 20/40

(52) U.S. Cl. CPC G06Q 20/3827; G06Q 20/4014

(57) ABSTRACT

Disclosed are a method and apparatus of proving a continuous action uniqueness. The method includes setting information on each of a plurality of actions performed by a user to a plurality of terminal nodes, grouping the plurality of terminal nodes in units of ‘n’ (where, ‘n’ is a natural number of 2 or more) and setting a parent node of the plurality of terminal nodes based on a combination of information corresponding to the grouped nodes, constructing a Hash tree by generating a Hahs tree root based on a combination of information corresponding to the parent node, and constructing a new Hash tree based on information about a new action and information corresponding to the Hash tree root when the new action subsequent to the plurality of actions is performed by the user.

### CROSS-REFERENCE TO RELATED APPLICATIONS

A claim for priority under 35 U.S.C. § 119 is made to Korean Patent Application No. 10-2022-0167050 filed on Dec. 2, 2022 in the Korean Intellectual Property Office, the entire contents of which are hereby incorporated by reference.

### BACKGROUND

Embodiments of the inventive concept described herein relate to a method and apparatus for proving an action uniqueness. More particularly, embodiments of the inventive concept relate to a method and apparatus for proving a continuous action uniqueness using a cryptographic hash.

Recently, technology related to blockchain-based non-fungible tokens (NFT) is being developed, and the scope of use is also expanding. The NFT refers to a specific cryptographic digital asset that may not be replaced. The NFT is being used as a tool to create the possibility of asset interoperability not only in games and art, but also in various fields.

Currently, systems for creating and trading individual NFTs are widely used, and services and products linked to NFTs are sold and distributed in various industries.

However, in conventional art, when a user completes a specific action (e.g., a transfer procedure during the house contract process), creates/updates the NFT based on the action, and then performs subsequent actions, there is a problem that the user had to prove each time that he or she is the actor of the specific action that is completed.

### SUMMARY

Embodiments of the inventive concept provide a method and apparatus for proving a continuous action uniqueness using a cryptographic hash.

The problems to be solved by the inventive concept are not limited to the problems mentioned above, and other problems not mentioned may be clearly understood by those skilled in the art from the description below.

According to an embodiment of the inventive concept, a method for proving a continuous action uniqueness performed by an apparatus, includes setting information on each of a plurality of actions performed by a user to a plurality of terminal nodes, grouping the plurality of terminal nodes in units of ‘n’ (where, ‘n’ is a natural number of 2 or more) and setting a parent node of the plurality of terminal nodes based on a combination of information corresponding to the grouped nodes, constructing a Hash tree by generating a Hash tree root based on a combination of information corresponding to the parent node, and constructing a new Hash tree based on information about a new action and information corresponding to the Hash tree root when the new action subsequent to the plurality of actions is performed by the user.

According to an embodiment, the information on the each of the plurality of actions may include at least one of a type of the plurality of actions, a result calculated through the plurality of actions, an ID of operations configuring each of the plurality of actions, information about a subject who performed the plurality of actions, and identification information of the plurality of actions.

According to an embodiment, the setting of the parent node of the plurality of terminal nodes may further include obtaining a cryptographic hash value by applying a hash function to the information corresponding to the grouped nodes, and setting the obtained cryptographic hash value to the parent node of the plurality of terminal nodes.

According to an embodiment, the information corresponding to the Hash tree root may include an ID (identifier) to identify the user.

According to an embodiment, the constructing of the new Hash tree may include combining the information about the new action and the information corresponding to the Hash tree root, and obtaining a new cryptographic hash value by applying the hash function to the combination of the information corresponding to the new action and the information corresponding to the Hash tree root.

According to an embodiment, the constructing of the new Hash tree may include setting the obtained new cryptographic hash value to a new terminal node, and constructing the new Hash tree based on the plurality of terminal nodes and the new terminal node.

According to an embodiment, an updated ID to identify the user may be set for a Hash tree root of the new Hash tree.

According to an embodiment, the method may further include providing information indicating that the Hash tree is updated to be changed to the new Hash tree, based on the new action being performed by the user.

According to an embodiment of the inventive concept, an apparatus includes a memory that stores at least one process for proving a continuous action uniqueness, and a processor that performs operations depending on the process, and the processor is configured to set information on each of a plurality of actions performed by a user to a plurality of terminal nodes, to group the plurality of terminal nodes in units of ‘n’ (where, ‘n’ is a natural number of 2 or more) and set a parent node of the plurality of terminal nodes based on a combination of information corresponding to the grouped nodes, to construct a Hash tree by generating a Hash tree root based on a combination of information corresponding to the parent node, and to construct a new Hash tree based on information about a new action and information corresponding to the Hash tree root when the new action subsequent to the plurality of actions is performed by the user.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram of a system for implementing a method that proves a continuous action uniqueness using a cryptographic hash, according to an embodiment of the inventive concept;

FIG. 2 is a block diagram illustrating a configuration of an apparatus that proves a continuous action uniqueness using a cryptographic hash, according to an embodiment of the inventive concept;

FIG. 3 is a flowchart illustrating a method that proves a continuous action uniqueness using a cryptographic hash, according to an embodiment of the inventive concept;

FIG. 4 is a diagram for describing an example of an ID indicating each action step being applicable to the inventive concept; and

FIGS. 5 and 6 are diagrams for describing an example of a Hash tree being applicable to the inventive concept.

### DETAILED DESCRIPTION

The same reference numerals refer to the same elements throughout the specification. In the inventive concept, all elements of embodiments are not described, and general contents in the technical field to which the inventive concept pertains or repeated contents between the embodiments will not be described. In the specification, terms such as “parts”, “modules”, “members”, and “blocks” may be implemented by using software or hardware. In some embodiments, a plurality of parts, modules, members, or blocks are implemented with a single element, or one part, module, member, or block may include a plurality of elements.

Throughout the specification, when a part is referred to as being “connected” to another part, it includes “directly connected” and “indirectly connected,” and the “indirectly connected” includes “connected through a wireless communication network.”

In addition, when a part “includes” an element, another element may be further included, rather than excluding the existence of another element, unless otherwise described.

Throughout the specification, when a member is described as being located “on” another member, this includes not only cases where the member is in contact with another member, but also cases where another member exists between the two members.

Terms “first”, “second”, and the like are used herein to distinguish one element from another element, and the elements are not limited to the terms described above.

As used herein, singular forms “a” and “an” are intended to include plural forms as well, unless the context clearly indicates otherwise.

Reference numerals in operations are used for the sake of convenience of description and do not describe an order of the operations, and the operations may be performed through an order different from the described order unless the context clearly indicates a specific order.

Hereinafter, a principle of action and embodiments of the inventive concept will be described with reference to the accompanying drawings.

In this specification, an ‘apparatus according to the inventive concept’ includes all various apparatuses that may perform computational processing and may provide results to a user. For example, the apparatus according to the inventive concept may include all of a computer, a server apparatus, and a portable terminal, or may take the form of any one of them.

In this case, the computer may include, for example, a notebook computer, a desktop, a laptop, a tablet PC, a slate PC, etc., which are equipped with a web browser.

The server apparatus is a server that processes information by communicating with an external apparatus, and may include an application server, computing server, database server, file server, game server, mail server, proxy server, web server, etc.

The portable terminal is, for example, a wireless communication device that guarantees portability and mobility, and may include all types of handheld-based wireless communication devices such as a PCS (Personal Communication System), GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a WiBro (Wireless Broadband Internet) terminal, and a smart phone, and wearable devices such as watches, rings, bracelets, anklets, necklaces, glasses, contact lenses, or head-mounted-device (HMD).

In describing the inventive concept, a “hash function” refers to a function that maps data of arbitrary length to data of fixed length, and a “hash value” refers to a value obtained through the hash function. The “Hash value” may be expressed as a hash code, a hash checksum, or a hash.

The “Hash function” may be divided into a cryptographic hash function and a non-cryptographic hash function, and an example of the cryptographic hash function may include a SHA series hash function. An example of the SHA series hash function is “SHA-256”. The SHA-256 consists of 256 bits and may return a string of 64 characters. Data calculated through the cryptographic hash function may be expressed as a cryptographic hash.

In describing the inventive concept, a “Hash tree” is composed of terminal nodes of the hash value of data (e.g., One User's consecutive transaction data on block chain, etc.), and refers to a structure in which a Hash tree root (i.e., root node) is composed based on the terminal nodes. In detail, the “Hash tree root” is a hash calculated based on the hash value of each data, and the corresponding data may be verified through the Hash tree root.

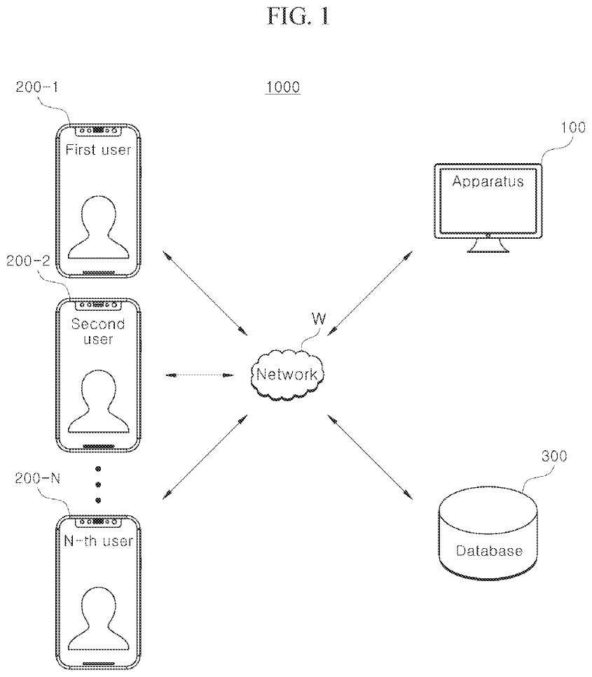

FIG. 1 is a schematic diagram of a system 1000 for implementing a method that proves a continuous action uniqueness using a cryptographic hash, according to an embodiment of the inventive concept.

As illustrated in FIG. 1, the system 1000 for implementing a method that proves a continuous action uniqueness using a cryptographic hash may include an apparatus 100, terminal devices 200-1, 200-2, . . . , 200-N used by a plurality of users, and a database 300.

In this case, in FIG. 1, although a case in which the apparatus 100 is implemented in the form of a single desktop, and the terminal devices 200-1, 200-2, . . . , 200-N used by a plurality of users are implemented in the form of a smart phone is illustrated, but is not limited thereto. As described above, the apparatus 100 may refer to various types of apparatuses or a group of apparatuses in which one or more types of apparatuses are connected.

The apparatus 100 included in the system 1000, the terminal devices 200-1, 200-2, . . . , 200-N used by the plurality of users, and the database 300 may perform communication through a network W. In this case, the network W may include a wired network and a wireless network. For example, the network may include various networks such as a local area network (LAN), a metropolitan area network (MAN), a wide area network (WAN), etc.

In addition, the network W may include a known world wide web (WWW). However, the network W according to an embodiment of the inventive concept is not limited to the networks listed above, and may include at least some of a known wireless data network, a known telephone network, and a known wired and wireless television network.

The apparatus 100 may perform a method of proving the continuous action uniqueness using a cryptographic hash. In detail, the apparatus 100 may set information about each of a plurality of (continuous) actions to a plurality of terminal nodes, and may set a parent node of the plurality of terminal nodes based on a combination of information corresponding to the terminal nodes.

The apparatus 100 may construct a Hash tree by generating a Hash tree root based on a combination of information corresponding to the set parent node. In this case, the Hash tree may correspond to an ID of the user (i.e., the subject who performed a plurality of (continuous) actions).

When a new action that follows a plurality of actions is performed by the user, the apparatus 100 may construct a new Hash tree based on information about the new action and information corresponding to the Hash tree root.

Operations related to this will be described in detail with reference to the drawings described later.

The terminal devices 200-1, 200-2, . . . , 200-N used by the plurality of users may own and/or trade NFTs. As an example, a first user (or the terminal device 200-1 used by the first user) may generate a block in which information about a plurality of (continuous) actions is set.

In this case, a block refers to a bundle of valid information and may include a block hash value that serves as a block identifier, block header information, and transaction-related information. The terminal device 200-1 used by the first user may issue/generate the NFT based on the generated block.

In this case, the terminal device 200-1 of the first user may be implemented as a component of the apparatus 100. In detail, the apparatus 100 may generate a block in which information about a plurality of (continuous) actions is set, and generate/create the NFT through the generated block.

The database 300 may store the Hash tree constructed based on information about each of a plurality of (continuous) actions. In addition, the database 300 may store the Hash tree constructed based on information on actions performed consecutively to the plurality of actions and a Hash tree root generated in advance.

Although FIG. 1 illustrates the case where the database 300 is implemented outside the apparatus 100, the database 300 may also be implemented as a component of the apparatus 100.

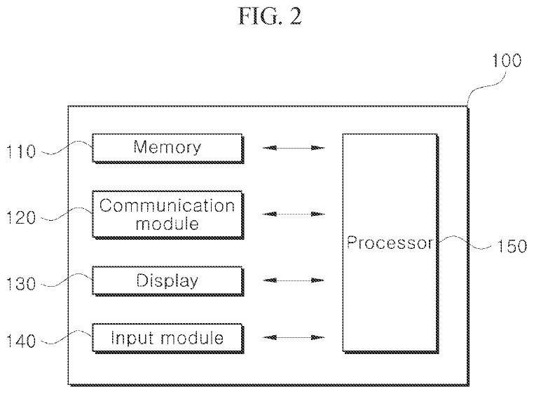

FIG. 2 is a block diagram illustrating a configuration of the apparatus 100 that proves a continuous action uniqueness using a cryptographic hash, according to an embodiment of the inventive concept.

As illustrated in FIG. 2, the apparatus 100 may include a memory 110, a communication module 120, a display 130, an input module 140, and a processor 150. However, the apparatus 100 is not limited to thereto, and the software and hardware configuration of the apparatus 100 may be modified/added/omitted depending on the required operation within the scope obvious to those skilled in the art.

The memory 110 may store data supporting various functions of the apparatus 100 and a program for the operation of the processor 150, may store input/output data (e.g., the Hash tree constructed based on information about each of the plurality of (continuous) actions, etc.), and may store a plurality of application programs (application programs or applications) running on the apparatus, and data and instructions for the operation of the apparatus 100. At least some of these applications may be downloaded from an external server via wireless communication.

The memory 110 may include a storage medium that is implemented with at least one type of a flash memory, a hard disk, a solid state disk (SSD), a silicon disk drive (SDD), a multimedia card micro memory, a card-type memory (e.g., an SD memory or an XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and optical disk.

In addition, the memory 110 may include a database that is separate from the apparatus but is connected to the apparatus in a wired or wireless manner. In detail, the database illustrated in FIG. 1 may be implemented as a component of the memory 110.

The communication module 120 may include one or more components that enable communication with an external apparatus, and may include, for example, at least one of a broadcast reception module, a wired communication module, a wireless communication module, a short-range communication module, and a location information module.

Wired communication modules include various wired communication modules such as a Local Area Network (LAN) module, a Wide Area Network (WAN) module, or a Value Added Network (VAN) module, as well as various cable communication modules such as a USB (Universal Serial Bus), an HDMI (High Definition Multimedia Interface), a DVI (Digital Visual Interface), an RS-232 (recommended standard 232), a power line communication, or a POTS (plain old telephone service).

Wireless communication modules may include a wireless communication module that supports various wireless communication methods, such as a global system for mobile communication (GSM), a code division multiple access (CDMA), a wideband code division multiple access (WCDMA), a universal mobile telecommunications system (UMTS), a time division multiple access (TDMA), a long term evolution (LTE), 4G, 5G, 6G, etc., in addition to a Wi-Fi module and a wireless broadband module.

The display 130 displays (or outputs) information processed by the apparatus 100 (e.g., the Hash tree constructed based on information about each of a plurality of (continuous) actions, information indicating that the Hash tree is updated to a new Hash tree, etc.). For example, the display may display execution screen information of an application program (as an example, an application) running on the apparatus 100, or a UI (User Interface) and GUI (Graphic User Interface) information according to such execution screen information.

The input module 140 is for receiving information from the user. When information is input through a user input unit, the processor 150 may control the operation of the apparatus 100 to correspond to the input information.

The input module 140 may include hardware-type physical keys (e.g., buttons, dome switches, jog wheels, jog switches, etc., which are located on at least one of the front, back, and sides of the apparatus) and software-type touch keys. As an example, the touch key may include a virtual key, soft key, or visual key displayed on the touch screen type display 130 through software processing, or may include a touch key placed in a part other than the touch screen. Meanwhile, the virtual key or visual key may be displayed on the touch screen in various forms, and may include, for example, graphic, text, icon, video or a combination thereof.

The processor 150 may control the overall operation and functions of the apparatus 100. In detail, the above-described memory 110 stores processes for controlling the operation of components within the apparatus 100, and the processor 150 may operate according to the processes. In this case, the memory 110 and the processor 150 may each be implemented as separate chips. Alternatively, the memory 110 and processor 150 may be implemented as a single chip.

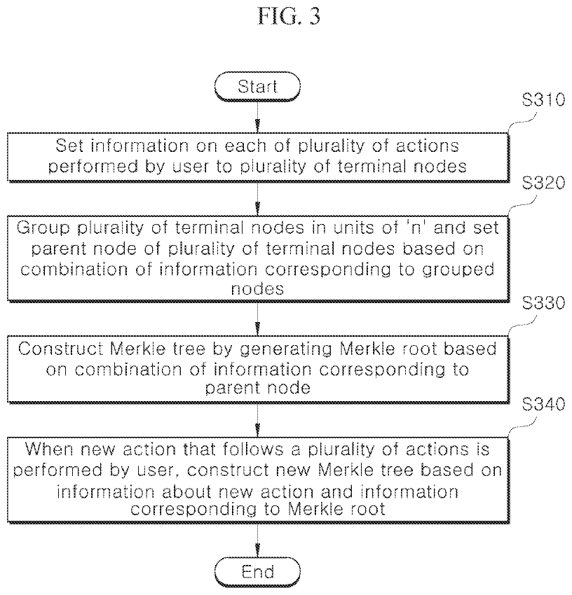

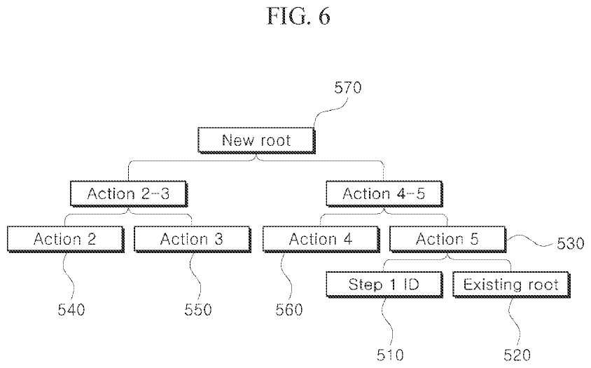

In addition, to implement various embodiments according to the inventive concept described in FIGS. 3 to 6 below on the apparatus 100, the processor 150 may control any one or a combination of the above-described components.

FIG. 3 is a flowchart illustrating a method that proves a continuous action uniqueness using a cryptographic hash, according to an embodiment of the inventive concept.

The processor 150 of the apparatus 100 may set information on each of a plurality of actions performed by the user to a plurality of terminal nodes (S310).

As an example, the processor 150 may set information about each of a plurality of (continuous) actions to a terminal node of a Hash tree structure.

As another example, the processor 150 may set information about each of a plurality of (continuous) actions to a terminal node of a Hash tree structure. In detail, the processor 150 may obtain a cryptographic hash value by applying a hash function to information about each of a plurality of (continuous) actions, and may set the obtained cryptographic hash value to a terminal node of the Hash tree structure.

In this case, the information about each of the plurality of actions may include at least one of a type of the plurality of actions (e.g., transaction activity, etc.), a result calculated through the plurality of actions, information about the subject who performed the plurality of actions, an ID of steps configuring each of the plurality of actions, and identification information for the plurality of actions (e.g., IDs corresponding to the plurality of actions, etc.).

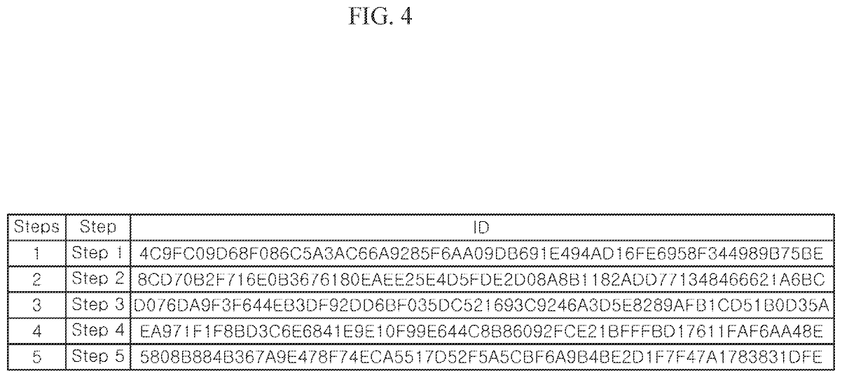

Referring to FIG. 4, an ID of a step configuring a specific action is illustrated. The ID of each step may be data calculated by applying a cryptographic hash function to information about each step that constitutes a specific action.

The processor 150 may group a plurality of terminal nodes in units of ‘n’ and may set a parent node of the plurality of terminal nodes based on a combination of information corresponding to the grouped nodes (S320).

As an example, the processor 150 may group a plurality of terminal nodes in units of two. In this case, the processor 150 may arbitrarily group a plurality of terminal nodes in units of two. As another example, the processor 150 may sort information (or cryptographic hash values for the information) corresponding to a plurality of terminal nodes in ascending (or descending) order, and then may sequentially group the corresponding information (or cryptographic hash values for the information) in units of two.

In addition, the processor 150 may obtain a cryptographic hash value for a combination of information (or cryptographic hash values for the information) on a plurality of actions corresponding to the grouped nodes.

As an example, the processor 150 combines information (or a cryptographic hash value for that information) about actions corresponding to grouped nodes, and may obtain additional cryptographic hash values by applying the hash function to the combined information (or cryptographic hash values of the combined information). The apparatus 100 may set the obtained additional cryptographic hash value as the parent node of the grouped node.

The processor 150 may construct a Hash tree by generating a Hash tree root based on a combination of information corresponding to the parent node (S330).

In detail, the processor 150 may repeat operation S320 until a Hash tree root is generated (that is, until a root node of a terminal node corresponding to information on each of a plurality of actions is generated).

In detail, the processor 150 may group the parent nodes generated in operation S320 in units of two. The processor 150 may obtain an additional cryptographic hash value for a combination of information (or cryptographic hash values of the information) corresponding to a plurality of parent nodes. The processor 150 may set the obtained additional cryptographic hash value as the parent node of the grouped parent node. The processor 150 may generate a Hash tree by repeating the above-described operations to generate a Hash tree root (i.e., root node).

In this case, information corresponding to the Hash tree root of the Hash tree may include an ID for identifying the user (who performed the plurality of (continuous) actions).

As an example, as illustrated in FIG. 4, it is assumed that four NFTs are generated (or issued) by the terminal device of the first user. The processor 150 may set an address of each NFT (or a cryptographic hash value of the address) as the terminal node.

The processor 150 may apply a hash function to the combination of information (or a cryptographic hash value of the information) for each of action 1 and action 2 corresponding to first and second terminal nodes 410 and 420 to obtain a hash value, and may set the obtained hash value to a first parent node 450.

The processor 150 may apply a hash function to the combination of information (or a cryptographic hash value of the information) for each of action 3 and action 4 corresponding to third and fourth terminal nodes 430 and 440 to obtain a hash value, and may set the obtained hash value to a second parent node 460.

The processor 150 may apply a hash function to the combination of hash values corresponding to the first and second parent nodes 450 and 460 to obtain a new hash value, and may set the obtained new hash value to a Hash tree root 470. Information corresponding to the Hash tree root 470 may include an ID for identifying a user (who performed the plurality of (continuous) actions).

When a new action that follows a plurality of actions is performed by the user, the processor 150 may generate a new Hash tree based on information about the new action and information corresponding to the Hash tree root (S340).

In detail, the processor 150 may combine information about the new action (or a cryptographic hash value of the information about the new action) and information corresponding to the Hash tree root (pre-generated). In this case, the information about the new action may include at least one of a type of new action, a result calculated through the new action, an ID of the step composing the new action, information about the subject who performed the new action, and identification information of the new action.

The processor 150 may obtain a new cryptographic hash value by applying a hash function to the information (or the cryptographic hash value of information about the new action) about the combined new action and information corresponding to the Hash tree root.

As an example, information corresponding to the (pre-generated) Hash tree root may be implemented as expressed in Equation 1 below. In Equation 1, an action M may mean information about action M (or a cryptographic hash value of the information), and a hash(x) may mean a predefined hash function.

### Equation 1

Hash tree root=hash(Σₜ, hashₜ) where t=node number at top level, and hashⱼ=hash(Σᵢ hash(action)) where k=tree depth level (0<k<tree depth), i=child number (0<i≤number of children for each node), j=node number (0<j≤number of node at tree level k), 1=action number (0<1≤n)

The processor 150 may set the obtained new cryptographic hash value to a new terminal node (of a new Hash tree). In this case, the information (i.e., information about action M+1) set to the new terminal node may be implemented as expressed in Equation 2. The action M+1 may mean a new continuous action newly performed by the user.

### Equation 2

The new terminal node (i.e., information about the action M+1)=hash (last action M+previous Hash tree root)

The processor 150 may construct a new Hash tree based on the plurality of terminal nodes and the new terminal node set in operation S310. In addition, an updated ID to identify the user may be set for the Hash tree root of the newly constructed Hash tree.

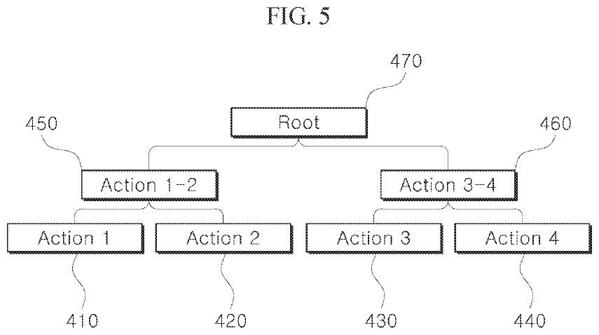

As illustrated in FIG. 5, the processor 150 may obtain the cryptographic hash value by applying a hash function to the combination of information 510 (or a hash value of the corresponding information) about a new action (or a new action consisting of step 1) and a pre-generated Hash tree root 520. The processor 150 may set the obtained cryptographic hash value to a new node (i.e., a node corresponding to a new action) 530.

In addition, the processor 150 may generate a new Hash tree based on (pre-generated) nodes 540, 550, and 560 and the new node 530. Operation of generating the new Hash tree has been described with reference to S320 to S330, so additional description will be omitted to avoid redundancy. An updated ID to identify the user may be set for a Hahs tree root 570 of the newly constructed Hash tree.

The subject of the action corresponding to the terminal node of the Hash tree may be automatically proven as the user through the Hash tree root (i.e., the user's ID) (due to characteristics of the Hash tree). When a new action is performed, the correlation (i.e., the user who performed each action is the same) between each action may be proven by generating a cryptographic hash value with respect to the combination of the new action and the Hash tree root of the pre-generated Hash tree. Accordingly, it may be proven that a plurality of continuous actions are the user's unique actions.

As another example in the inventive concept, when a new action is performed by the user, the apparatus may provide information indicating that the Hash tree is updated to a new Hash tree to the terminal device used by the user. In detail, when a new action is performed following a previously performed action, the apparatus may generate a new Hash tree based on information about the new action and may provide the generated Hash tree to the terminal device used by the user.

Meanwhile, the disclosed embodiments may be implemented as a recording medium storing instructions executable by a computer. The instructions may be stored in the form of a program code, and may generate, when executed by a processor, a program module such that operations of the disclosed embodiments may be performed. The recording medium may be implemented as a computer-readable recording medium.

The computer-readable recording medium includes all kinds of recording media in which instructions capable of being interpreted by the computer are stored. For example, the computer-readable recording medium may include a read only memory (ROM), a random access memory (RAM), a magnetic tape, a magnetic disc, a flash memory, an optical data storage device, and the like.

According to the means for solving the above-described problem of the inventive concept, a method and apparatus for proving a continuous action uniqueness using a cryptographic hash may be provided.

In addition, according to the means for solving the above-described problem of the inventive concept, it is possible to efficiently prove that a continuous action is a unique action of the actor by automatically verifying the proof of the actor commonly used in the continuous action and the proof of completion of the previous step.

The effects of the inventive concept are not limited to the aforementioned effects, and other effects not mentioned herein will be clearly understood from the above description by those skilled in the art to which the inventive concept pertains.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method of proving a continuous action uniqueness performed by an apparatus, the method comprising:
setting information on each of a plurality of actions performed by a user to a plurality of terminal nodes;
grouping the plurality of terminal nodes in units of ‘n’ (where, ‘n’ is a natural number of 2 or more) and setting a parent node of the plurality of terminal nodes based on a combination of information corresponding to the grouped nodes;
constructing a Hash tree by generating a Hash tree root based on a combination of information corresponding to the parent node; and
constructing a new Hash tree based on information about a new action and information corresponding to the Hash tree root when the new action subsequent to the plurality of actions is performed by the user.

2. The method of claim 1, wherein the information on the each of the plurality of actions includes at least one of a type of the plurality of actions, a result calculated through the plurality of actions, an ID of operations configuring each of the plurality of actions, information about a subject who performed the plurality of actions, and identification information of the plurality of actions.

3. The method of claim 2, wherein the setting of the parent node of the plurality of terminal nodes further includes:
obtaining a cryptographic hash value by applying a hash function to the information corresponding to the grouped nodes, and setting the obtained cryptographic hash value to the parent node of the plurality of terminal nodes.

4. The method of claim 3, wherein the information corresponding to the Hahs tree root includes an ID (identifier) to identify the user.

5. The method of claim 4, wherein the constructing of the new Hash tree includes:
combining the information about the new action and the information corresponding to the Hash tree root; and
obtaining a new cryptographic hash value by applying the hash function to the combination of the information corresponding to the new action and the information corresponding to the Hash tree root.

6. The method of claim 5, wherein the constructing of the new Hash tree includes:
setting the obtained new cryptographic hash value to a new terminal node; and
constructing the new Hash tree based on the plurality of terminal nodes and the new terminal node.

7. The method of claim 6, wherein an updated ID to identify the user is set for a Hash tree root of the new Hash tree.

8. The method of claim 7, further comprising:
providing information, which indicates that the Hash tree is updated to be changed to the new Hash tree, based on the new action being performed by the user.

9. An apparatus comprising:
a memory configured to store at least one process for proving a continuous action uniqueness; and
a processor configured to perform operations depending on the process, and
wherein the processor is configured to:
set information on each of a plurality of actions performed by a user to a plurality of terminal nodes;
group the plurality of terminal nodes in units of ‘n’ (where, ‘n’ is a natural number of 2 or more) and set a parent node of the plurality of terminal nodes based on a combination of information corresponding to the grouped nodes;
construct a Hash tree by generating a Hash tree root based on a combination of information corresponding to the parent node; and
construct a new Hahs tree based on information about a new action and information corresponding to the Hash tree root when the new action subsequent to the plurality of actions is performed by the user.

10. The apparatus of claim 9, wherein the information on the each of the plurality of actions includes at least one of a type of the plurality of actions, a result calculated through the plurality of actions, an ID of operations configuring each of the plurality of actions, information about a subject who performed the plurality of actions, and identification information of the plurality of actions.

11. The apparatus of claim 10, wherein the processor is configured to:
obtain a cryptographic hash value by applying a hash function to the information corresponding to the grouped nodes, and set the obtained cryptographic hash value to the parent node of the plurality of terminal nodes.

12. The apparatus of claim 11, wherein the information corresponding to the Hash tree root includes an ID (identifier) to identify the user.

13. The apparatus of claim 12, wherein the processor is configured to:
combine the information about the new action and the information corresponding to the Hash tree root; and
obtain a new cryptographic hash value by applying the hash function to the combination of the information corresponding to the new action and the information corresponding to the Hash tree root.

14. The apparatus of claim 13, wherein the processor is configured to:
set the obtained new cryptographic hash value to a new terminal node; and
construct the new Hash tree based on the plurality of terminal nodes and the new terminal node.

15. The apparatus of claim 14, wherein an updated ID to identify the user is set for a Hash tree root of the new Hash tree.

16. The apparatus of claim 15, wherein the processor is configured to:
provide information, which indicates that the Hash tree is updated to be changed to the new Hash tree, based on the new action being performed by the user.
